(19) United States
(12) Patent Application Publication
(10) Pub. No.: US 2018/0278922 A1
(43) Pub. Date: Sep. 27, 2018

(54) Wireless earpiece with a projector

(71) Applicant: BRAGI GmbH, München (DE)

(72) Inventor: Peter Vincent Boesen, München (DE)

(73) Assignee: BRAGI GmbH, München (DE)

(21) Appl. No.: 15/926,762

(22) Filed: Mar. 20, 2018

Related U.S. Application Data
(60) Provisional application No. 62/475,098, filed on Mar. 22, 2017.

(51) Int. Cl. H04N 13/363; H04N 13/365; H04N 13/139; H04R 1/10

(52) U.S. Cl. CPC H04N 13/363; H04N 13/365; H04N 2213/001; H04R 1/1091; H04R 2420/07; H04N 13/139

(57) ABSTRACT

A method of projecting content onto a surface using a wireless earpiece includes determining the content to display onto the surface, sensing at least one characteristic associated with the surface, formatting the content in accordance with the at least one characteristic associated with the surface and projecting the content onto the surface using a projector of the wireless earpiece. A wireless earpiece includes an earpiece housing, a processor, at least one sensor and a projector. The processor determines content to be displayed in accordance with a user preference and one or more characteristics associated with a surface using data measured by one or more of the sensors and formats the content in accordance with one or more of the characteristics associated with the surface. The projector projects the content onto the surface in accordance with one or more of the characteristics associated with the surface.

### PRIORITY STATEMENT

This application claims priority to Application No. 62/475,098, titled Wireless earpiece with a projector, which is hereby incorporated by reference in its entirety.

### FIELD OF THE INVENTION

The present invention relates to wireless earpieces. More particularly, but not exclusively, the present invention relates to one or more wireless earpieces with a projector.

### BACKGROUND

Wireless earpieces or other hearables have tremendous possibilities and are ideally suited for conveying audio information to users. However, one of the disadvantages of wireless earpieces relates to the inability to display information. What is needed is a wireless earpiece and improved methods for displaying information using a wireless earpiece.

### SUMMARY

Therefore, it is a primary object, feature, or advantage of the present invention to improve over the state of the art.

It is a further object, feature, or advantage of the present invention to have a wireless earpiece with a projector.

It is a still further object, feature, or advantage of the present invention to project content onto a surface using the projector of the wireless earpiece.

Another object, feature, or advantage is to determine a characteristic of the surface and project the content onto the surface using the projector in accordance with each characteristic of the surface.

Yet another object, feature, or advantage of the present invention is to have more than one projector for projecting content onto a surface for third parties to view.

Yet another object, feature, or advantage of the present invention is display content from the projector onto a surface in accordance with user preferences.

Yet another object, feature, or advantage of the present invention is to orient the projector in response to a movement of a user when wearing a wireless earpiece.

Yet another object, feature, or advantage of the present invention is to have separate modes for a single user and multiple users of a set of wireless earpieces.

Yet another object, feature, or advantage of the present invention is to project the content onto a surface stereoscopically if multiple users are using a set of wireless earpieces.

Yet another object, feature, or advantage of the present invention is to project separate pieces of content onto separate surfaces if multiple users are using a set of wireless earpieces.

Yet another object, feature, or advantage of the present invention is to have a separate flashlight mode.

Yet another object, feature, or advantage of the present invention is to allow for content streamed from an outside source to be projected onto a surface.

In one embodiment, a method of projecting content onto a surface using a wireless earpiece includes using a processor of the wireless earpiece to determine the content to display onto the surface, using at least one sensor of the wireless earpiece to sense at least one characteristic associated with the surface, formatting, by the processor of the wireless earpiece, the content in accordance with the at least one characteristic associated with the surface and projecting the content onto the surface using a projector of the wireless earpiece.

One or more of the following features may be included. The content may be determined in accordance with a selection provided by a user of the wireless earpiece. The content may be determined automatically performed in accordance with user preferences. One or more characteristics associated with a surface may be selected from a set comprising a distance between the wireless earpiece and the surface, a shape associated with the surface, and a contour associated with the surface. The wireless earpiece may be part of a set of wireless earpieces and the projector of each earpiece may be forward facing. A mode of operation associated with the set of wireless earpieces may be determined from a set that includes a normal mode of operation, a shared mode of operation, and a flashlight mode. The content may be projected stereoscopically onto the surface by the set of wireless earpieces in the shared mode of operation. One or more wireless earpieces of the set of wireless earpieces may determine a second surface to display the content, determine one or more characteristics associated with the second surface, format the content in accordance with one or more of the characteristics associated with the second surface, and project the content onto the second surface using a second projector associated with one or more of the wireless earpieces in the shared mode of operation. One or more wireless earpieces of the set of wireless earpieces may determine a second surface to display the content, determine additional content to display on the second surface, determine one or more characteristics associated with the second surface, format the additional content in accordance with one or more of the characteristics associated with the second surface, and project the additional content onto the second surface using a second projector associated with the one or more of the wireless earpieces in the shared mode of operation. The projector may be oriented in response to a movement by a user.

In another embodiment, a wireless earpiece includes an earpiece housing, a processor disposed within the earpiece housing, at least one sensor operatively connected to the processor; and a projector operatively connected to the processor. The processor is configured to determine content to be displayed in accordance with a user preference and one or more characteristics associated with a surface using data measured by the one or more of the sensors and the projector is configured to project the content onto the surface in accordance with one or more of the characteristics associated with the surface.

One or more of the following features may be included. One or more of the sensors may include a radar sensor and the data may include the position of one or more objects sensed by the radar sensor and one or more characteristics associated with one or more of the objects. The processor may be further configured to use the data to select the surface from one or more of the objects sensed by the radar sensor to project the content. One or more of the characteristics of the surface may be selected from a set that includes a distance between the wireless earpiece and the surface, a shape associated with the surface, and a contour associated with the surface. The projector may be positioned on the earpiece housing to project the content in a forward direction when the wireless earpiece is worn by a user. The projector may be disposed within the earpiece housing and enclosed by a substantially transparent material. The projector may protrude from the earpiece housing and may include an actuator configured to orient the projector toward the surface. The projector may be oriented in accordance with a factor selected from a set that includes a projection angle, an intensity, a focus point, a zoom factor, a skew factor, and reflection from the surface. A second projector may be positioned on the earpiece housing to project the content in a backward direction when the wireless earpiece is worn by a user. The projector may include a laser positioned to emit the content at a microelectromechanical mirror for projecting the content onto the surface.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by any object, feature, or advantage stated herein.

### BRIEF DESCRIPTION OF THE DRAWINGS

Illustrated embodiments of the disclosure are described in detail below with reference to the attached drawing figures, which are incorporated by reference herein.

FIG. 1 is a pictorial representation of a communication environment.

FIG. 2 is a pictorial representation of some of the sensors of the wireless earpieces.

FIG. 3 is a block diagram of a wireless earpiece system.

FIG. 4 is a flowchart of a process for projecting content from projector enhanced wireless earpieces worn by a user.

FIG. 5 is a flowchart of another process for projecting content from projector enhanced wireless earpieces.

FIG. 6 illustrates a flowchart of a method of projecting content onto a surface using a projector of a wireless earpiece.

FIG. 7 depicts a computing system.

### DETAILED DESCRIPTION

The present invention provides a wireless earpiece and a method of projecting content onto a surface using a wireless earpiece. The wireless earpiece may represent a set of wireless earpieces worn by a user for communications (e.g., phone or video calls), transcription, entertainment (e.g., listening to sound associated with audio, video, or other content, etc.), receiving biometric feedback, interaction with an application, or any number of other features, functions, or processes. For example, the set of wireless earpieces may include a left wireless earpiece and a right wireless earpiece. Both wireless earpieces may include a projector that may function together when worn by a single user or that may function independently when the left wireless earpiece and the right wireless earpiece are worn by different users. In another embodiment, only one wireless earpiece of the set of wireless earpieces may include a projector.

The projectors may represent an optical projection apparatus utilized to display light onto one or more surfaces. In one embodiment, the projector may be integrated with the wireless earpiece. The projector may represent a module or component that connects to the wireless earpiece. For example, the wireless earpiece may include an interface for connecting the projector module to the another wireless earpiece. The projector of the wireless earpiece may include any number of components such as lenses, controls (e.g., power, zoom, focus, sensing, etc.), actuators, light sensors, filters, amplifiers, reflectors, and so forth. The projectors may also include light sources such as light emitting diodes (LEDs), lasers, lamps, bulbs, and other light sources. In one embodiment, the projectors may be configured to move, position, and adapt to changing circumstances. For example, the projectors may utilize one or more actuators or pivots to point at a specified surface.

The wireless earpiece may determine whether a projection surface is available. The projection surface may represent any number of surfaces or objects such as a wall, a screen, a user's hand, a floor, a ceiling, and so forth. In one embodiment, the projector may determine a distance to the projection surface. Any number of settings, configurations, or options of the wireless earpiece may be utilized to project the content onto the projection surface. For example, the light emissions of the wireless earpiece may be focused and directed as needed. In some examples, the content is provided by a set of wireless earpieces working together. As a result, the wireless earpieces may direct and focus the projectors of the wireless earpieces to properly display the content to the user or one or more other parties.

Content projected by the wireless earpiece may include images, text, data, videos, graphics, or so forth. The content may represent any number of different types of data including streaming, real-time, or discrete data. The content may also be associated with audio received or otherwise processed by the wireless earpiece. Common examples of content may include user biometrics, video communications, text or email messages, movies, pictures, application data, audio transcription data, alerts, time and temperature information, calendar information, and so forth.

The wireless earpiece may be utilized to project content even when the wireless earpiece is not being worn. For example, the wireless earpiece may determine an available projection surface. Selected content may be then projected onto the available service.

A set of wireless earpieces may be configured to automatically or manually determine that the set of wireless earpieces are being utilized by separate users. In one embodiment, the set of wireless earpieces may utilize biometrics, such as heart rate, skin conductivity, ear/facial mapping, voice recognition, or so forth to identify one or more of the users utilizing the set of wireless earpieces. The set of wireless earpieces may also utilize location or other combinations of biometrics and information to determine that one or more of the wireless earpieces are being separately utilized. As a result, projectors associated with each of the one or more wireless earpieces may be effectively controlled.

The set of wireless earpieces may also be automatically configured to project content separately for two different users. For example, one or more of the wireless earpieces may utilize separate transceivers when the wireless earpieces are worn by a single user or two users (e.g., switching from a near field magnetic induction (NFMI) transceiver to a BLUETOOTH/Wi-Fi transceiver in response to utilization by two users). The transceivers may utilize distinct modes, channels, stacks, interfaces, or hardware to enable communications between each of the wireless earpieces, an associated wireless device, and so forth. For example, a dual mode BLUETOOTH transceiver may be utilized to expand the available separation distance between one or more of the wireless earpieces while also enabling communications with the associated wireless device (e.g., smart phone, tablet, etc.). The set of wireless earpieces may also continue to perform biometric and environmental measurements for one or both of the users. The measurements may be projected, logged, streamed, played to the respective user/both users, or otherwise communicated or saved. For example, the applicable information may be shared between the users based on user preferences, commands, settings, configurations, or other applicable information. One or more of the wireless earpieces may be a master device that communicates with the other wireless earpieces as well as the associated wireless device(s). In another example, each of the wireless earpieces may be enabled and configured to communicate with one or more associated wireless device(s) as well as each other.

In addition, each of the wireless earpieces of the set of wireless earpieces may act as an input/output device for providing voice, gesture, touch, or other input to control, manage, or interact with another wireless earpiece, one or more associated wireless devices, systems, equipment or components, or executed applications or software. Each wireless earpiece may operate actively or passively to perform any number of tasks, features, and functions based on a user request, one or more user preferences, or so forth. The described embodiments may represent hardware, software, firmware, or a combination thereof. One or more of the wireless earpieces may also be an integrated part of a virtual reality or augmented reality system.

Furthermore, each of the wireless earpieces of the set of wireless earpieces may be utilized to play music or audio, track user biometrics, perform communications (e.g., two-way, alerts, etc.), provide feedback/input, or any number of other tasks. Each of the wireless earpieces may manage execution of software or sets of instructions stored in an on-board memory to accomplish various tasks. Each wireless earpiece may also be utilized to control, communicate, manage, or interact with a number of other computing, communications, or wearable devices, such as smart phones, laptops, personal computers, tablets, holographic displays, virtual reality systems, gaming devices, projection systems, vehicles, smart glasses, helmets, smart glass, watches or wrist bands, chest straps, implants, displays, clothing, or so forth. In one embodiment, each wireless earpiece may be integrated with, control, or otherwise communicate with a personal area network. A personal area network is a network for data transmissions among devices, such as personal computing, communications, camera, vehicles, entertainment, and medical devices. The personal area network may utilize any number of wired, wireless, or hybrid configurations and may be stationary or dynamic. For example, the personal area network may utilize wireless network protocols or standards, such as INSTEON, IrDA, Wireless USB, near field magnetic induction (NFMI), BLUETOOTH, Z-Wave, ZigBee, Wi-Fi, ANT+ or other applicable radio frequency signals. In one embodiment, the personal area network may move with the user.

Additionally, each wireless earpiece of the set of wireless earpieces may include any number of sensors for sensing user biometrics, such as pulse rate, blood pressure, blood oxygenation, temperature, orientation, calories expended, blood or sweat chemical content, voice and audio output, impact levels, and orientation (e.g., body, head, etc.). The sensors may also sense the user's location, position, velocity, impact levels, and so forth. The sensors may also receive user input representing commands or selections associated with one or more personal devices of the personal area network. For example, the user input detected by the wireless earpieces may include voice commands, head motions, finger taps, finger swipes, motions or gestures, or other user inputs sensed by the wireless earpieces. The user input may be received, parsed, and converted into commands associated with the input that may be utilized internally by the wireless earpieces and associated projectors or sent to one or more external devices, such as a tablet computer, smart phone, secondary wireless earpiece, or so forth. Each wireless earpiece may also perform sensor measurements for the user to read any number of user biometrics. The user biometrics may be analyzed including measuring deviations or changes of the sensor measurements over time, identifying trends of the sensor measurements, and comparing the sensor measurements to control data for the user.

Finally, each wireless earpiece of the set of wireless earpieces may also measure environmental conditions, such as temperature, location, barometric pressure, humidity, radiation, wind speed, and other applicable environmental data. Each wireless earpiece may also communicate with one or more external devices to receive additional sensor measurements. The wireless earpieces may communicate with the external devices to receive available information, which may include information received through one or more networks, such as the Internet. The detection of biometrics and environmental information may be enhanced utilizing each of the wireless earpieces of a set as a measurement device. In addition, the separate measurements may be utilized for mapping or otherwise distinguishing applicable information. The environmental conditions and information may be projected by the user based on a user selection, automated process, user preferences, or so forth.

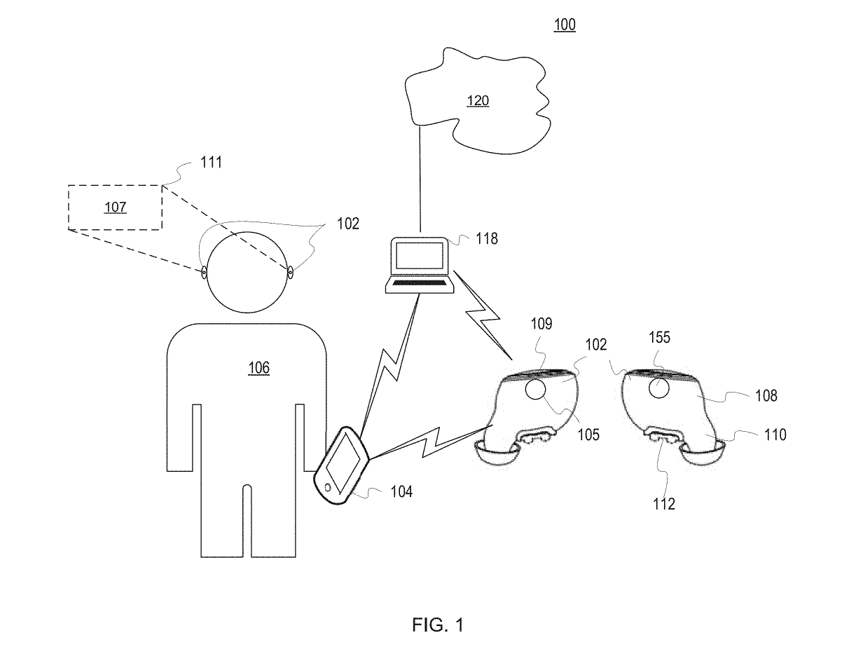

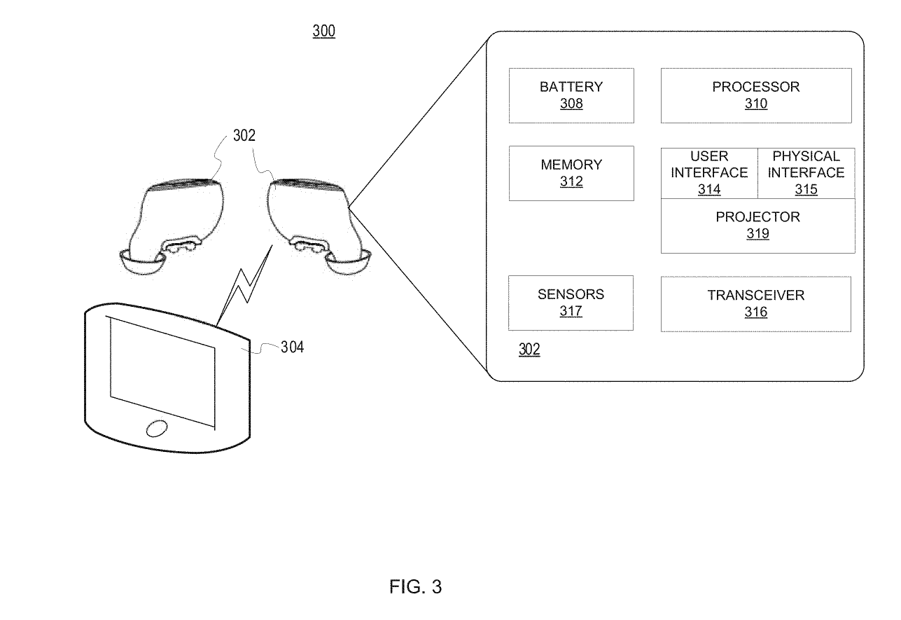

FIG. 1 is a pictorial representation of a communications environment 100. The wireless earpieces 102 may be configured to communicate with each other and with one or more wireless devices, such as a wireless device 104, a personal computer 118, or another set or individual wireless earpieces (not shown). The wireless earpieces 102 may be worn by a user 106 and are shown both as worn and separately from their positioning within the ears of the user 106 for purposes of visualization. A block diagram of the wireless earpieces 102 is further shown in FIG. 3 to illustrate components and operation of the wireless earpieces 102. As subsequently described, the wireless earpieces 102 may be separated for utilization by a first user, such as user 106, and a second user (not shown). The applicable functionality, utilization, description, and so forth is applicable to the user 106 or multiple users (e.g., a first user and a second user). For example, description applicable to the user 106 may be applicable to multiple users when the wireless earpieces 102 are separated as is herein contemplated, described, and shown.

The wireless earpieces 102 include a earpiece housing 108 shaped to fit substantially within the ears of the user 106. The earpiece housing 108 is a support structure that at least partially encloses and houses the electronic components of the wireless earpieces 102. The earpiece housing 108 may be composed of a single structure or multiple structures that are interconnected. An exterior portion of the wireless earpieces 102 may include a first set of sensors shown as infrared sensors 109. The infrared sensors 109 may include emitter and receivers that detects and measures infrared light radiating from objects in their field of view. The infrared sensors 109 may detect gestures, touches, or other user input against an exterior portion of the wireless earpieces 102 that is visible when worn by the user 106. The infrared sensors 109 may also detect infrared light or motion. The infrared sensors 109 may be utilized to determine whether the wireless earpieces 102 are being worn, moved, approached by a user, set aside, stored in a smart case, placed in a dark environment, or so forth. The sensors 112 may also be integrated in the earpiece housing 108 or any other portion of the wireless earpieces 102.

The earpiece housing 108 defines an extension 110 configured to fit substantially within the ear of the user 106. The extension 110 may include one or more speakers or vibration components for interacting with the user 106. The extension 110 may be removably covered by one or more sleeves. The sleeves may be changed to fit the size and shape of the user's ears. The sleeves may come in various sizes and have extremely tight tolerances to fit the user 106 and one or more other users that may utilize the wireless earpieces 102 during their expected lifecycle. In another embodiment, the sleeves may be custom built to support the interference fit utilized by the wireless earpieces 102 while also being comfortable when worn. The sleeves are shaped and configured to not cover various sensor devices of the wireless earpieces 102. Separate sleeves may be utilized if different users are wearing the wireless earpieces 102.

The wireless earpieces 102 may include projectors 105, 155. In one embodiment, one or more of the projectors 105, 155 may project content 107 onto a surface 111. In addition, the wireless earpieces 102 may also have a front-facing projector as well as a side-facing or rear-facing projector. However, in other embodiments the projectors 105, 155 may face any number of directions.

Each of the projectors 105, 155 may include a light emitting diode (LED), a digital light processing (DLP) system or chip, a laser light source or any other projection element suitable for projecting information. The laser light source may allow the content 107 to always be in focus. In another embodiment, the LED may be used with an integrated sensor to determine the distance to the display surface, thereby allowing optimal clarity for the content 107. In one embodiment, the projectors 105, 155 may be fixed position projectors, only displaying information straight on. In another embodiment, the projectors 105, 155 may pivot, rotate, or otherwise move allowing the angle of projection to be adjusted for displaying the content 107 on the surface 111. This may allow a user to display the content 107 on a desired surface without unnecessary head/neck movements.

The projectors 105, 155 may protrude slightly from the earpiece housing 108 of the wireless earpieces 102 in order to facilitate movement. In another embodiment, each of the projectors 105, 155 may be enclosed within the earpiece housing 108. For example, the projectors 105, 155 may be enclosed within a transparent material for protection. In yet another embodiment, the projectors 105, 155 may extend or protrude from the earpiece housing 108 when utilized. Any number of motors, actuators, pivots, mounts, linkages, pulleys, springs, or so forth may be utilized to move, rotate, or otherwise position the projectors 105, 155. For example, each of the projector 105, 155 may extend from the earpiece housing 108 in response to a command or request to utilize one or more of the projectors 105, 155. Each of the projectors 105, 155 may utilize one or more mirrors, lenses, or wave guides to project the content 107. For example, one or more of the projectors 105, 155 may be a rotationally mounted fiber optic laser projector for projecting the content 107 onto the surface 111.

The earpiece housing 108 or the extension 110 (or other portions of the wireless earpieces 102) may include sensors 112 for sensing pulse, blood oxygenation, temperature, voice characteristics, skin conduction, glucose levels, impacts, activity level, position, location, orientation, as well as any number of internal or external user biometrics. In other embodiments, the sensors 112 may be positioned to contact or be proximate the epithelium of the external auditory canal or auricular region of the user's ears when worn. For example, the sensors 112 may represent various metallic sensor contacts, optical interfaces, or even micro-delivery systems for receiving, measuring, and delivering information and signals. Small electrical charges or spectroscopy emissions (e.g., various light wavelengths) may be utilized by the sensors 112 to analyze the biometrics of the user 106 including pulse, blood pressure, skin conductivity, blood analysis, sweat levels, and so forth.

The sensors 112 may also include radar sensors for sensing the proximity to objects, users, or surfaces, such as the surface 111. As a result, the projector 105 may be oriented to display the content 107 on the surface 111 so that the content 107 is visible to the user 106. For example, the sensors 112 may sense a position, location, and orientation of the user 106 including the users head and neck. Radar sensors may include LIDAR that may detect fixed or moving objects (e.g., furniture, fixtures, individuals, pets, vehicles, etc.).

The sensors 112 may include optical sensors that may emit and measure reflected light within the ears of the user 106 for determining any number of biometrics. The optical sensors may also be utilized as a second set of sensors for determining when the wireless earpieces 102 are in use, stored, charging, or otherwise positioned. In another embodiment, the wireless earpieces 102 may not include sensors 112. For example, the wireless earpieces 102 may be utilized primary for inputting and outputting audio information for the user 106. The wireless earpieces 102 may also represent a wireless headphone, such as an over-ear or on-ear headphone. The various components of the wireless earpieces 102 may be integrated in the wireless headphone. In another embodiment, the wireless earpieces 102 may be docked or integrated into headphones.

The sensors 112 may be utilized to provide relevant information that may be communicated through a virtual assistant of the wireless earpieces 102. As described, the sensors 112 may include one or more microphones that may be integrated with the earpiece housing 108 or the extension of the wireless earpieces 102. For example, an external microphone may sense environmental noises as well as the user's voice as communicated through the air of the communications environment 100. An ear-bone or internal microphone may sense vibrations or sound waves communicated through the head of the user 102 (e.g., bone conduction, etc.). In other embodiments, the wireless earpieces 102 may not have sensors 112 or may have very limited sensors.

In some applications, temporary adhesives or securing mechanisms (e.g., clamps, straps, lanyards, extenders, wires, etc.) may be utilized to ensure that the wireless earpieces 102 remain in the ears of the user 106 even during the most rigorous physical activities or to ensure that if they do fall out they are not lost or broken. For example, the wireless earpieces 102 may be utilized or shared during marathons, swimming, team sports, biking, hiking, parachuting, business meetings, military exercises, or other activities or actions. In one embodiment, miniature straps may attach to the wireless earpieces 102 with a clip on the strap securing the wireless earpieces to the clothes, hair, or body of the user. The wireless earpieces 102 may be configured to play music or audio, receive and make phone calls or other communications, determine ambient environmental conditions (e.g., temperature, altitude, location, speed, heading, etc.), read user biometrics (e.g., heart rate, motion, temperature, sleep, blood oxygenation, voice output, calories burned, forces experienced, etc.), execute one or more applications related to specific for performing specific purposes, or receive user input, feedback, or instructions. The wireless earpieces 102 may also be utilized with any number of automatic assistants, such as Siri, Cortana, Alexa, Google, Watson, or other smart assistants/artificial intelligence systems.

The communications environment 100 may further include the personal computer 118. The personal computer 118 may communicate with one or more wired or wireless networks, such as a network 120. The personal computer 118 may represent any number of devices, systems, equipment, or components, such as a laptop, server, tablet, medical system, gaming device, virtual/augmented reality system, or so forth. The personal computer 118 may communicate utilizing any number of standards, protocols, or processes. For example, the personal computer 118 may utilize a wired or wireless connection to communicate with the wireless earpieces 102, the wireless device 104, or other electronic devices. The personal computer 118 may utilize any number of memories or databases to store or synchronize biometric information associated with the user 106, data, passwords, or media content. The personal computer 118 may also be utilized to establish the user preferences, settings, and other information for controlling the projector 105. For example, the user preferences may specify how and when the content 107 is displayed to the user 106.

The wireless earpieces 102 may determine their position with respect to each other as well as the wireless device 104 and the personal computer 118. For example, position information for the wireless earpieces 102 and the wireless device 104 may determine proximity of the devices in the communications environment 100. For example, global positioning information or signal strength/activity may be utilized to determine proximity and distance of the devices to each other in the communications environment 100. In one embodiment, the distance information may be utilized to determine whether biometric analysis may be displayed to a user. For example, the wireless earpieces 102 may be required to be within four feet of the wireless device 104 and the personal computer 118 in order to display biometric readings or receive user input. The transmission power or amplification of received signals may also be varied based on the proximity of the devices in the communications environment 100. For example, if different users are wearing the wireless earpieces 102, the signal strength may be increased or decreased based on the relative distance between the wireless earpieces to enable communications with one another or an associated wireless device.

The wireless earpieces 102 and the corresponding sensors 112 (whether internal or external) may be configured to take a number of measurements or log information and activities during normal usage. This information, data, values, and determinations may be reported to the user(s) or otherwise utilized. The sensor measurements may be utilized to extrapolate other measurements, factors, or conditions applicable to the user 106 or the communications environment 100. For example, the sensors 112 may monitor the user's usage patterns or light sensed in the communications environment 100 to enter a full power mode in a timely manner. The user 106 or another party may configure the wireless earpieces 102 directly or through a connected device and app (e.g., mobile app with a graphical user interface) to set power settings (e.g., preferences, conditions, parameters, settings, factors, etc.) or to store or share biometric information, audio, and other data. In one embodiment, the user may establish the light conditions or motion that may activate the full power mode or that may keep the wireless earpieces 102 in a sleep or low power mode. As a result, the user 106 may configure the wireless earpieces 102 to maximize the battery life based on motion, lighting conditions, and other factors established for the user 106. For example, the user 106 may set the wireless earpieces 102 to enter a full power mode only if positioned within the ears of the user 106 within ten seconds of being moved, otherwise the wireless earpieces 102 remain in a low power mode to preserve battery life. This setting may be particularly useful if the wireless earpieces 102 are periodically moved or jostled without being inserted into the ears of the user 106.

The user 106 or another party may also utilize the wireless device 104 to associate user information and conditions with the user preferences. For example, an application executed by the wireless device 104 may be utilized to specify the conditions that may “wake up” the projectors 105 of the wireless earpieces 102 to automatically or manually communicate information, warnings, data, or status information to the user. In addition, the enabled functions (e.g., sensors, projectors, transceivers, vibration alerts, speakers, lights, etc.) may be selectively activated based on the user preferences as set by default, by the user, or based on historical information. The wireless earpieces 102 may be adjusted or trained over time to become even more accurate in adjusting to habits, requirements, requests, activations, or other processes or functions performed. For example, in response to detecting the wireless earpieces 102 are worn by a first user and a second user, the wireless earpieces 102 may enable projectors 105, 155 to function independently as well as synchronize or coordinate functionality of the wireless earpieces 102. In one embodiment, the wireless earpieces 102 may utilize historical information to generate default values, baselines, thresholds, policies, or settings for determining when and how the virtual assistant performs various communications, actions, and processes. As a result, the wireless earpieces 102 may effectively manage the automatic and manually performed processes of the wireless earpieces 102 based on automatic detection of events and conditions (e.g., light, motion, user sensor readings, etc.) and user specified settings.

The wireless earpieces 102 may include any number of sensors 112 and logic for sensing user biometrics such as pulse rate, skin conduction, blood oxygenation, temperature, calories expended, blood or excretion chemistry, voice and audio output, position, or orientation (e.g., body, head, etc.). The sensors 112 may also sense the user's location, position, velocity, impact levels, and so forth. Any of the sensors 112 may be utilized to detect or confirm light, motion, or other parameters that may affect how the wireless earpieces 102 manage, utilize, and initialize the virtual assistant. The sensors 112 may also receive user input and convert the user input into commands or selections made across the personal devices of the personal area network. For example, the user input detected by the wireless earpieces 102 may include voice commands, head motions, finger taps, finger swipes, motions or gestures, or other user inputs sensed by the wireless earpieces. The user input may be determined by the wireless earpieces 102 and converted into authorization commands that may be sent to one or more external devices, such as the wireless device 104, the personal computer 118, a tablet computer, secondary wireless earpieces, or so forth. For example, the user 106 may create a specific head motion and voice command that when detected by the wireless earpieces 102 are utilized to send a request to a virtual assistant (implemented by the wireless \ earpieces 102/wireless device 104) to tell the user 106 her current heart rate, speed, and location. Any number of actions may also be implemented by the virtual assistant or logic of the wireless earpieces 102 in response to specified user input. The projectors 105, 155 may include a vision or camera system for receiving user input through hand motions, gestures, or other visible actions performed by the user. For example, the projectors 105, 155 may be utilized to provide a heads-up display or temporary monitor from which the user 106 may make various selections.

The sensors 112 may perform the measurements with regard to the user 106 and communications environment 100 or may communicate with any number of other sensory devices, components, or systems in the communications environment 100. In one embodiment, the communications environment 100 may represent all or a portion of a personal area network. A personal area network is a network for data transmissions among devices, components, equipment, and systems, such as personal computers, communications devices, cameras, vehicles, entertainment/media devices, and medical devices. The wireless earpieces 102 may be utilized to control, communicate, manage, or interact with one or more of the devices, components, equipment, and systems of the personal area network as well as other wearable devices or electronics such as smart glasses, helmets, watches or wrist bands, other wireless earpieces, chest straps, implants, displays, clothing, or so forth. The personal area network may utilize any number of wired, wireless, or hybrid configurations and may be stationary or dynamic. For example, the personal area network may utilize wireless network protocols or standards, such as INSTEON, IrDA, Wireless USB, BLUETOOTH, Z-Wave, ZigBee, Wi-Fi, ANT+ or other applicable radio frequency signals. In one embodiment, the personal area network may move with the user 106.

The communications environment 100 may include any number of devices, components, or so forth that may communicate with each other directly or indirectly through a wireless (or wired) connection, signal, or link. The communications environment 100 may include one or more networks and network components and devices represented by the network 120, such as routers, servers, signal extenders, intelligent network devices, computing devices, or so forth. In one embodiment, the network 120 of the communications environment 100 represents a personal area network as previously disclosed. A virtual assistant as herein described may also be utilized to control the projectors 105, 155 and for any number of devices in the communications environment 100.

Communications within the communications environment 100 may occur through the network 120, a Wi-Fi network, or directly between devices such as the wireless earpieces 102 and the wireless device 104. The network 120 may include or communicate with any number of hard wired networks, local area networks, coaxial networks, fiber-optic networks, powerline networks, or other types of networks. For example, the network 120 may communicate with a wireless network using a Wi-Fi, cellular (e.g., 3G, 4G, 5G, PCS, GSM, etc.), BLUETOOTH, or other wireless technology standard. Communications within the communications environment 100 may be operated by one or more users, service providers, or network providers.

The wireless earpieces 102 may play, display, communicate, or utilize any number of alerts or communications to indicate the actions, activities, communications, mode, or status (e.g., in use, being implemented, etc.) of the projectors 105, 155 or one or more of the other components of the wireless earpieces 102. For example, one or more alerts may indicate when the wireless earpieces 102 are separated for utilization by different users, such as an audio alert indicating “sharing mode is activated.” The alerts may include any number of tones, verbal acknowledgements, tactile feedback, or other forms of communicated messages. For example, an audible alert and light flash from an LED may be utilized each time one of the wireless earpieces 102 activate one or more of the projectors 105, 155 to project content or receive user input. Verbal or audio acknowledgements, answers, and actions utilized by the wireless earpieces 102 are particularly effective because of user familiarity with such devices in standard smart phone and personal computers. The corresponding alert may also be communicated to the user 106, the wireless device 104, and the personal computer 118.

The wireless earpieces 102 may also vibrate, flash, play a tone or other sound, or give other indications of the actions, status, or processes being implemented. The wireless earpieces 102 may also communicate an alert to the wireless device 104 that shows up as a notification, message, in-app alert, or other indicator indicating changes in status, actions, commands, or so forth.

The wireless earpieces 102 as well as the wireless device 104 may include logic for automatically implementing a flashlight mode in response to motion, light, user activities, user biometric status, user location, user position, historical activity/requests, or various other conditions and factors of the communications environment 100. In one embodiment, one or more of the projectors 105, 155 may be utilized as a temporary flashlight displaying a white, red, green, blue, or other light color. During the flashlight mode, the wireless earpieces 102 may be activated to perform a specified activity or to “listen” or be prepared to “receive” user input, feedback, or commands for implementation. The projectors 105, 155 may be utilized to broadcast augmented reality content that may be applicable to the user's real-world environment, such as information, names, directions, highlighting, differentiation, markers, text, labels, or so forth.

The wireless device 104 may represent any number of wireless or wired electronic communications or computing devices, such as smart phones, laptops, desktop computers, control systems, tablets, displays, gaming devices, music players, personal digital assistants, vehicle systems, or so forth. The wireless device 104 may communicate utilizing any number of wireless connections, standards, or protocols (e.g., near field communications, NFMI, BLUETOOTH, Wi-Fi, wireless Ethernet, etc.). For example, the wireless device 104 may be a touch screen cellular phone that communicates with the wireless earpieces 102 utilizing BLUETOOTH communications. The wireless device 104 may implement and utilize any number of operating systems, kernels, instructions, or applications that may make use of the available sensor data sent from the wireless earpieces 102. For example, the wireless device 104 may represent any number of android, iOS, Windows, open platforms, or other systems and devices. Similarly, the wireless device 104 or the wireless earpieces 102 may execute any number of standard or specialized applications that utilize the user input, proximity data, biometric data, and other feedback from the wireless earpieces 102 to initiate, authorize, or perform the associated tasks.

As noted, the layout of the internal components of the wireless earpieces 102 and the limited space available for a product of limited size may affect where the sensors 112 may be positioned. The positions of the sensors 112 within each of the wireless earpieces 102 may vary based on the model, version, and iteration of the wireless earpieces 102 design and manufacturing process.

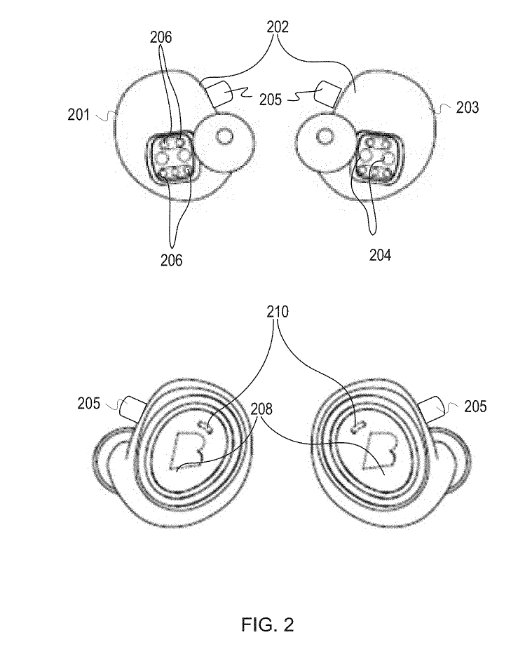

FIG. 2 is a pictorial representation of some of the components of the wireless earpieces 202 in accordance with illustrative embodiments. As shown the wireless earpieces 202 may include a left wireless earpiece 201 and a right wireless earpiece 203 that are representative of a set of wireless earpieces. In other embodiments, the set of wireless earpieces may include a number of left wireless earpieces 201 and right wireless earpieces 203. The illustrative embodiments may also be applicable to large numbers of wireless earpieces and may communicate directly or indirectly (e.g., mesh networking) with each other a wireless hub/wireless device or so forth.

As previously noted, the wireless earpieces 202 may include any number of components internal and/or external sensors. In one embodiment, the sensors may be utilized to determine environmental information and whether the wireless earpieces are being utilized by different users. Similarly, any number of other components or features of the wireless earpieces 202 may be managed based on the measurements made by the sensors to preserve resources (e.g., battery life, processing power, etc.). The sensors may make independent measurements or combined measurements utilizing the sensory functionality of each of the sensors to measure, confirm, or verify sensor measurements.

The components include projectors 205. The projectors 205 may be positioned in any number of positions. The projectors 205 are positioned on an earpiece housing of the wireless earpieces 202 so that they project content forward or in front of the user for visualization. In other embodiments, the projectors 205 may be positioned in any number of positions or locations of the wireless earpieces 202. The wireless earpieces 202 may also include a number of different projectors, such as a forward-facing set and a backward facing set for each of the wireless earpieces 202. A light or projection source within the projectors 205 may be configured to project content in any number of directions.

The projectors 205 may be positioned external to the earpiece housing of the wireless earpieces 202 or may be slidably mounted to the wireless earpieces (e.g., retractable). The projectors 205 may rotate, pivot, or otherwise move into position for projecting content. In one embodiment, the projectors 205 may be encased by a transparent cover, such as glass, plastic, or so forth. The cover may both protect the projectors 205 as well as functioning as a lens or focusing component. The light emitting portions of the projectors 205 may be covered, encased, or protected within the cover. The projectors 205 may also be integrated into the earpiece housing or other structures of the wireless earpieces 202. In other embodiments, the wireless earpieces 202 may be physically, magnetically, or wirelessly connected to other projectors or display components, such as smart glasses, wearable projectors, heads-up displays, vehicle systems, and so forth.

The sensors may include optical sensors 204, contact sensors 206, infrared sensors 208, and microphones 210. The optical sensors 204 may generate an optical signal that is communicated to the ear (or other body part) of the user and reflected. The reflected optical signal may be analyzed to determine blood pressure, pulse rate, pulse oximetry, vibrations, blood chemistry, and other information about the user. The optical sensors 204 may include any number of sources for outputting various wavelengths of electromagnetic radiation and visible light. Thus, the wireless earpieces 202 may utilize spectroscopy as it is known in the art and developing to determine any number of user biometrics.

The optical sensors 204 may be configured to detect ambient light proximate the wireless earpieces 202. The optical sensors 204 may also be configured to detect any number of wavelengths including visible light that may be relevant to light changes, approaching users or devices, and so forth. In one embodiment, the optical sensors 204 may also include an externally facing portion or component. For example, the optical sensors 204 may detect light and light changes in an environment of the wireless earpieces 202, such as in a room where the wireless earpieces 202 are located. The environmental conditions may be utilized to determine the amplitude, frequency range, projection direction, and other factors of the optical signals broadcast by the projectors.

The contact sensors 206 may be utilized to determine that the wireless earpieces 202 are positioned within the ears of the user. For example, conductivity of skin or tissue within the user's ear may be utilized to determine that the wireless earpieces are being worn. In other embodiments, the contact sensors 206 may include pressure switches, toggles, or other mechanical detection components for determining that the wireless earpieces 202 are being worn. The contact sensors 206 may measure or provide additional data points and analysis that may indicate the biometric information of the user. The contact sensors 206 may also be utilized to apply electrical, vibrational, motion, or other input, impulses, or signals to the skin of the user. In one embodiment, specific components and features of the wireless earpieces 202 may be activated only if the wireless earpieces are worn by the user (e.g., the contact sensors 206 or other sensors detect usage of the wireless earpieces 202).

The wireless earpieces 202 may also include infrared sensors 208. The infrared sensors 208 may be utilized to detect touch, contact, gestures, or other user input. The infrared sensors 208 may detect infrared wavelengths and signals. In another embodiment, the infrared sensors 208 may detect visible light or other wavelengths as well. The infrared sensors 208 may be configured to detect light or motion or changes in light or motion. Readings from the infrared sensors 208 and the optical sensors 204 may be configured to detect light or motion. The readings may be compared to verify or otherwise confirm light or motion. As a result, decisions regarding user input, biometric readings, environmental feedback, function implementation, and other measurements may be effectively implemented in accordance with readings form the sensors 200 as well as other internal or external sensors and the user preferences. The infrared sensors 208 may also be integrated in the optical sensors 204.

The wireless earpieces 210 may include microphones 210. The microphones 210 may represent external microphones as well as internal microphones. The external microphones may be positioned exterior to the body of the user as worn. The external microphones may sense verbal or audio input, feedback, and commands received from the user. The external microphones may also sense environmental, activity, and external noises and sounds. The internal microphone may be positioned against, proximate, or adjacent the body of the user. For example, the internal microphones may be within the user's ear when the wireless earpieces 202 are worn by the user. The internal microphone may represent an ear-bone or bone conduction microphone. The internal microphone may sense vibrations, waves, or sound communicated through the bones and tissue of the user's body (e.g., skull). The microphones 210 may sense content that is utilized by the wireless earpieces 202 to implement the processes, functions, and methods herein described. The audio input sensed by the microphones 210 may be filtered, amplified, or otherwise processed before or after being sent to the logic of the wireless earpieces 202.

The wireless earpieces 202 may include chemical sensors (not shown) that perform chemical analysis of the user's skin, excretions, blood, or any number of internal or external tissues or samples. For example, the chemical sensors may determine whether the wireless earpieces 202 are being worn by the user. The chemical sensor may also be utilized to monitor important biometrics that may be more effectively read utilizing chemical samples (e.g., sweat, blood, excretions, etc.). The chemical sensors may be non-invasive and may only perform chemical measurements and analysis based on the externally measured and detected factors. One or more probes, vacuums, capillary action components, needles, or other micro-sampling components may be utilized. Minute amounts of blood or fluid may be analyzed to perform chemical analysis that may be reported to the user and others. The sensors may include parts or components that may be periodically replaced or repaired to ensure accurate measurements. In one embodiment, the infrared sensors 208 may be a first sensor array and the optical sensors 204 may be a second sensor array.

FIG. 3 is a block diagram of a wireless earpiece system 300. As previously noted, the wireless earpieces 302 may be referred to or described herein as a pair (wireless earpieces) or singularly (wireless earpiece). The description may also refer to components and functionality of each of the wireless earpieces 302 collectively or individually. In one embodiment, the wireless earpiece system 300 may enhance communications and functionality of the wireless earpieces 302. In one embodiment, the wireless earpiece system 300 or wireless earpieces 302 may communicate directly or through one or more networks (e.g., Wi-Fi, mesh networks, cell networks, etc.).

As shown, the wireless earpieces 302 may be wirelessly linked to the wireless device 304. For example, the wireless device 304 may represent a smart phone. The wireless device 304 may also represent a gaming device, tablet computer, vehicle system (e.g., GPS, speedometer, pedometer, entertainment system, etc.), media device, smart watch, laptop, smart glass, or other electronic devices. User input, commands, and communications may be received from either the wireless earpieces 302 or the wireless device 304 for implementation on either of the devices of the wireless earpiece system 300 (or other externally connected devices).

The wireless device 304 may act as a logging tool for receiving information, data, or measurements made by the wireless earpieces 302 together or separately. For example, the wireless device 304 may receive or download biometric data from the wireless earpieces 302 in real-time for two users utilizing the wireless earpieces 302. As a result, the wireless device 304 may be utilized to store, display, and synchronize data for the wireless earpieces 302 as well as manage communications. For example, the wireless device 304 may display pulse, proximity, location, oxygenation, distance, calories burned, and so forth as measured by the wireless earpieces 302. The wireless device 304 may be configured to receive and display an interface, selection elements, and alerts that indicate conditions for sharing communications. For example, the wireless earpieces 302 may utilize factors, such as changes in motion or light, distance thresholds between the wireless earpieces 302 and/or wireless device 304, signal activity, user orientation, user speed, user location, environmental factors (e.g., temperature, humidity, noise levels, proximity to other users, etc.) or other automatically determined or user specified measurements, factors, conditions, or parameters to implement various features, functions, and commands. For example, a projector 319 may be controlled utilizing the information determined by the wireless earpieces 302 or by the wireless device 304.

The wireless device 304 may also include any number of optical sensors, touch sensors, microphones, and other measurement devices (sensors 317) that may provide feedback or measurements that the wireless earpieces 302 may utilize to determine an appropriate mode, settings, or enabled functionality. The wireless earpieces 302 and the wireless device 304 may have any number of electrical configurations, shapes, and colors and may include various circuitry, connections, and other components.

One or both of the wireless earpieces 302 may include a battery 308, a processor 310, a memory 312, a user interface 314, a physical interface 315, a transceiver 316, sensors 317, and a projector 319. The wireless device 304 may have any number of configurations and include components and features similar to the wireless earpieces 302 as are known in the art. The content displayed and projection functionality and logic may be implemented as part of the processor 310, user interface 314, projector 319, or other hardware, software, or firmware of the wireless earpieces 302 and/or wireless device 304.

The battery 308 is a power storage device configured to power the wireless earpieces 302. In other embodiments, the battery 308 may represent a fuel cell, thermal electric generator, piezo electric charger, solar charger, ultra-capacitor, or other existing or developing power storage technologies. The processor 310 preserves the capacity of the battery 308 by reducing unnecessary utilization of the wireless earpieces 302 in a full-power mode when there is little or no benefit to the user (e.g., the wireless earpieces 302 are sitting on a table or temporarily lost). The battery 308 or power of the wireless earpieces are preserved for when being worn or operated by the user. As a result, user satisfaction with the wireless earpieces 302 is improved and the user may be able to set the wireless earpieces 302 aside at any moment knowing that battery life is automatically preserved by the processor 310 and functionality of the wireless earpieces 302. In addition, the battery 308 may use just enough power for the transceiver 316 for communicating across a distance separating users of the wireless earpieces 302. The wireless earpieces 302 may include contacts, and interface, or ports for receiving a supplementary, attachable, or add-on battery. For example, a magnetic interface may be utilized to supply the wireless earpieces 302 with additional battery/power capacity.

The processor 310 is the logic that controls the operation and functionality of the wireless earpieces 302. The processor 310 may include circuitry, chips, and other digital logic. The processor 310 may also include programs, scripts, and instructions that may be implemented to operate the processor 310. The processor 310 may also represent an application specific integrated circuit (ASIC) or field programmable gate array (FPGA). In one embodiment, the processor 310 may execute instructions to manage the wireless earpieces 302 including interactions with the components of the wireless earpieces 302, such as the user interface 314, transceiver 316, and sensors 317.

The processor 310 may utilize data and measurements from the transceivers 316 and sensors 317 to determine whether the wireless earpieces 302 are being utilized by different users. For example, distance, biometrics, user input, and other application information, data, and measurements may be utilized to determine whether a standard mode for a single user or sharing mode for multiple users are implemented by the processor 310 and other components of the wireless earpieces 302. The processor 310 may control actions implemented in response to any number of measurements from the sensors 317, the transceiver 316, the user interface 314, or the physical interface 315 as well as user preferences 320 that may be user entered or other default preferences. For example, the processor 310 may initialize a sharing mode in response to any number of factors, conditions, parameters, measurements, data, values, or other information specified within the user preferences 320 or logic. The processor 310 may control the various components of the wireless earpieces 302 to implement the sharing mode. For example, projectors 319 of each of the wireless earpieces 302 may be utilized independently.

The processor 310 may implement any number of processes for the wireless earpieces 302, such as facilitating communications (e.g., video calls, phone calls, text/email messaging, etc.), listening to music, tracking biometrics or so forth. The wireless earpieces 302 may be configured to work together or completely independently based on the needs of the users. For example, the wireless earpieces 302 may be used by two different users at one time.

The processor 310 may also process user input to determine commands implemented by the wireless earpieces 302 or sent to the wireless device 304 through the transceiver 316. Specific actions may be associated with user input (e.g., voice, tactile, orientation, motion, gesture, etc.). For example, the processor 310 may implement a macro allowing the user to associate frequently performed actions with specific commands/input implemented by the wireless earpieces 302. In one example, the wireless earpieces 302 may display content through the projector 319 in response to a verbal user command to “play” or “display” a selected piece of content.

The processor 310 may include circuitry or logic enabled to control execution of a set of instructions. The processor 310 may be one or more microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks.

The memory 312 is a hardware element, device, or recording media configured to store data or instructions for subsequent retrieval or access at a later time. The memory 312 may represent static or dynamic memory. The memory 312 may include a hard disk, random access memory, cache, removable media drive, mass storage, or configuration suitable as storage for data, instructions, and information. In one embodiment, the memory 312 and the processor 310 may be integrated. The memory 312 may use any type of volatile or non-volatile storage techniques and mediums. The memory 312 may store information related to the status of a user, wireless earpieces 302, wireless device 304, and other peripherals, such as a tablet, smart glasses, a smart watch, a smart case for the wireless earpieces 302, a wearable device, and so forth. The memory 312 may store display instructions, programs, drivers, or an operating system for controlling the projector 319 and user interface 314 including one or more LEDs or other light emitting components, speakers, tactile generators (e.g., vibrator), and so forth. The memory 312 may also store thresholds, conditions, signal or processing activity, proximity data, and so forth.

The transceiver 316 is a component comprising both a transmitter and receiver which may be combined and share common circuitry on a single housing. The transceiver 316 may communicate utilizing BLUETOOTH, Wi-Fi, ZigBee, Ant+, near field communications, wireless

USB, infrared, mobile body area networks, ultra-wideband communications, cellular (e.g., 3G, 4G, 5G, PCS, GSM, etc.), infrared, or other suitable radio frequency standards, networks, protocols, or communications. The transceiver 316 may be a hybrid or multi-mode transceiver that supports a number of different communications with distinct devices simultaneously. For example, the transceiver 316 may communicate with the wireless device 304 or other systems utilizing wired interfaces (e.g., wires, traces, etc.), NFC, or Bluetooth communications as well as with the other wireless earpieces utilizing NFMI. The transceiver 316 may also detect amplitudes and signal strength to infer distance between the wireless earpieces 302 as well as the wireless device 304.

The components of the wireless earpieces 302 may be electrically connected utilizing any number of wires, contact points, leads, busses, wireless interfaces, or so forth. In addition, the wireless earpieces 302 may include any number of computing and communications components, devices or elements which may include busses, motherboards, printed circuit boards, circuits, chips, sensors, ports, interfaces, cards, converters, adapters, connections, transceivers, displays, antennas, and other similar components. The physical interface 315 is hardware interface of the wireless earpieces 302 for connecting and communicating with the wireless device 304 or other electrical components, devices, or systems.

The physical interface 315 may include any number of pins, arms, or connectors for electrically interfacing with the contacts or other interface components of external devices or other charging or synchronization devices. For example, the physical interface 315 may be a micro USB port. In one embodiment, the physical interface 315 is a magnetic interface that automatically couples to contacts or an interface of the wireless device 304. In another embodiment, the physical interface 315 may include a wireless inductor for sending communications and charging the wireless earpieces 302 without a physical connection to a charging device. The physical interface 315 may allow the wireless earpieces 302 to be utilized when not worn as a remote microphone and sensor system (e.g., seismometer, thermometer, light detection unit, motion detector, etc.). For example, measurements, such as noise levels, temperature, movement, and so forth may be detected by the wireless earpieces even when not worn. The wireless earpieces 302 may be utilized as a pair, independently, or when stored in a smart case. Each of the wireless earpieces 302 may provide distinct sensor measurements as needed. In one embodiment, the smart case may include hardware (e.g., logic, battery, transceiver, etc.) to integrate as part of a mesh network. For example, the smart case may be utilized as a node or relay within a mesh network for sending and receiving communications.

The user interface 314 is a hardware interface for receiving commands, instructions, or input through the touch (haptics) of the user, voice commands, or predefined motions. The user interface 314 may further include any number of software and firmware components for interfacing with the user. The user interface 314 may be utilized to manage and otherwise control the other functions of the wireless earpieces 302 including mesh communications. The user interface 314 may include the LED array, one or more touch sensitive buttons or portions, a miniature screen or display, or other input/output components (e.g., the user interface 314 may interact with the sensors 317 extensively). The user interface 314 may be controlled by the user or based on commands received from the wireless device 304 or a linked wireless device. In one embodiment, sharing modes and processes may be controlled by the user interface, such as recording communications, receiving user input for communications, sharing biometrics, queuing communications, sending communications, receiving user preferences for the communications, and so forth. The user interface 314 may also include a virtual assistant for managing the features, functions, and components of the wireless earpieces 302. In one embodiment, the user interface 314 may be integrated with the projector 319.

The projector 319 may represent any number of pico, miniature, micro, or other forms of projectors. The projector 319 may utilize lasers (e.g., solid state, laser diodes, gas lasers, etc.), light emitting diodes (LEDs), DLP, or other light source projector types. For example, the projector 319 may be a pico laser beam projection system utilizing red, green, and blue lasers as light sources that are reflected off of a constantly moving microelectromechanical systems (MEMS) mirror to reflect the images toward the selected surface. The projector 319 may include one or more galvanometers, controllers (digital-to-analog converters), digital multiplexors, dichroic mirrors, and other similar components that interface and interact with the other components of the wireless earpieces 302.

In one embodiment, the user may provide user input for the user interface 314 by tapping a touch screen or capacitive sensor once, twice, three times, or any number of times. Similarly, a swiping motion may be utilized across or in front of the user interface 314 (e.g., the exterior surface of the wireless earpieces 302) to implement a predefined action. Swiping motions in any number of directions or gestures may be associated with specific activities or actions, such as project content, play music, pause, fast forward, rewind, activate a virtual assistant, listen for commands, report biometrics, enabled sharing communications, and so forth.

The swiping motions may also be utilized to control actions and functionality of the wireless device 304 or other external devices (e.g., smart television, camera array, smart watch, etc.). For example, the user may select to receive discrete or streaming content at the wireless earpieces 302 through the wireless device 304. The user may also provide user input by moving his head in a particular direction or motion or based on the user's position or location. For example, the user may utilize voice commands, head gestures, or touch commands to change the processes implemented by the wireless earpieces 302 as well as the processes executed or content displayed by the wireless device 304. The user interface 314 may also provide a software interface including any number of icons, soft buttons, windows, links, graphical display elements, and so forth.

The sensors 317 may be integrated with the user interface 314 to detect or measure the user input. For example, infrared sensors positioned against an outer surface of the wireless earpieces 302 may detect touches, gestures, or other input as part of a touch or gesture sensitive portion of the user interface 314. The outer or exterior surface of the user interface 314 may correspond to a portion of the wireless earpieces 302 accessible to the user when the wireless earpieces are worn within the ears of the user.

In addition, the sensors 317 may include pulse oximeters, accelerometers, thermometers, barometers, radiation detectors, gyroscopes, magnetometers, global positioning systems, beacon detectors, inertial sensors, photo detectors, miniature cameras, and other similar instruments for detecting user biometrics, environmental conditions, location, utilization, orientation, motion, and so forth. The sensors 317 may provide measurements or data that may be utilized to select, activate, or otherwise utilize the mesh network. Likewise, the sensors 317 may be utilized to awake, activate, initiate, or otherwise implement actions and processes utilizing conditions, parameters, values, or other data within the user preferences 320. For example, the optical biosensors within the sensors 317 may determine whether the wireless earpieces 302 are being worn and when a selected gesture to activate the projector 319 is provided by the user.

The wireless device 304 may include components similar in structure and functionality to those shown for the wireless earpieces 302. The computing device may include any number of processors, batteries, memories, busses, motherboards, chips, transceivers, peripherals, sensors, displays, cards, ports, adapters, interconnects, and so forth. In one embodiment, the wireless device 304 may include one or more processors and memories for storing instructions. The instructions may be executed as part of an operating system, application, browser, or so forth to implement the features herein described. In one embodiment, the wireless earpieces 302 may be magnetically, wirelessly, or physically coupled to the wireless device 304 to be recharged, synchronized, or stored. In one embodiment, the wireless device 304 may include applications that are executed to enable projection from the wireless earpieces 302. For example, the projection enablement or initiation may be selected from the wireless earpieces 302 themselves or from an application utilized by the wireless device 304 to communicate with the wireless earpieces 302. Separate applications executed by the wireless earpieces 302 and the wireless device 304 may function as a single application to enhance functionality, interface and interact, and perform the processes herein described.

The wireless device 304 may be utilized to adjust the user preferences 320 including settings, thresholds, activities, conditions, environmental factors, and so forth utilized by the wireless earpieces 302 and the wireless device 304. For example, the wireless device 304 may utilize a graphical user interface that allows the user to more easily specify any number of conditions, values, measurements, parameters, and factors that are utilized to perform projection, communications, and share content between the wireless earpieces 302.

The wireless device 304 may also include sensors for detecting the location, orientation, and proximity of the wireless earpieces 302 to the wireless device 304. The wireless earpieces 302 may turn off communications to the wireless device 304 in response to losing a status or heart beat connection to preserve battery life and may only periodically search for a connection, link, or signal to the wireless device 304 or the other wireless earpiece(s). The wireless earpieces 302 may also turn off components, enter a low power or sleep mode, or otherwise preserve battery life in response to no interaction with the user for a time period, no detection of the presence of the user (e.g., touch, light, conductivity, motion, etc.), or so forth.

As originally packaged, the wireless earpieces 302 and the wireless device 304 may include peripheral devices such as charging cords, power adapters, inductive charging adapters, additional batteries, attachable projectors, solar cells, batteries, lanyards, additional light arrays, speakers, smart case covers, transceivers (e.g., Wi-Fi, cellular, etc.), or so forth. In one embodiment, the wireless earpieces 302 may include a smart case (not shown). The smart case may include an interface for charging the wireless earpieces 302 from an internal battery as well as through a plugged connection. The smart case may also utilize the interface or a wireless transceiver to log utilization, biometric information of the user, and other information and data. The smart case may also be utilized as a repeater, a signal amplifier, relay, or so forth between the wireless earpieces 302 or as part of a mesh network (e.g., a node in the mesh network).

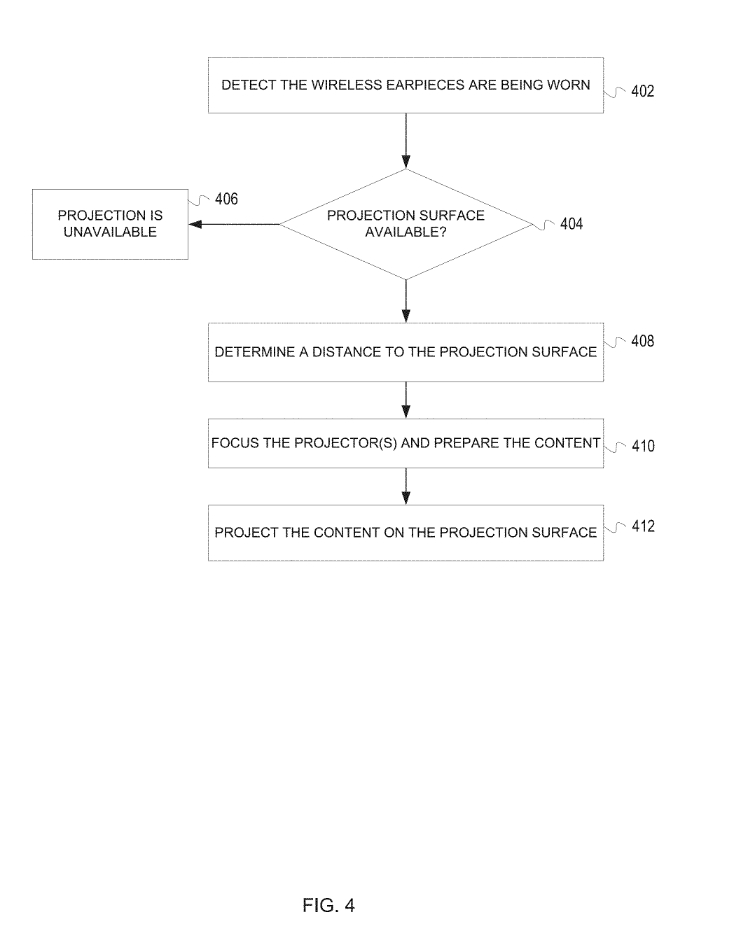

FIG. 4 is a flowchart of a process for projecting content from projector enhanced wireless earpieces worn by a user in accordance with an illustrative embodiment. In one embodiment, the process of FIGS. 4 5, and/or 6 may be implemented by each of the wireless earpieces of a set/pair independently or jointly. In another embodiment, the process of FIG. 4 5, and/or 6 may be implemented by wireless earpieces in communication with a wireless device (jointly the “system”). The wireless earpieces and wireless device described may represent devices, such as those shown in FIGS. 1 2, and 3.

The process may begin by detecting whether the wireless earpieces are being worn (step 402). The wireless earpieces may utilize any number of sensors, components, or detection processes to determine that one or more of the wireless earpieces are being worn or utilized. For example, detection of a heartbeat may be utilized to determine the wireless earpieces are being worn. In other examples, the optical sensors, touch/contacts sensors, contacts, accelerometers, gyroscopes, infrared sensors, or other sensors of the wireless earpieces may be utilized to determine the wireless earpieces are being worn and used. During step 402, the wireless earpieces may also determine whether the wireless earpieces are being used by separate users any number of circumstances, conditions, or factors. For example, detecting that the wireless earpieces have been removed from a smart case may indicate that the wireless earpieces are being worn or prepared to be worn. In one embodiment, the wireless earpieces may self-determine that they are being worn. In another embodiment, the wireless earpieces may receive user input or commands indicating that they are being worn or otherwise utilized. Step 402 may include any number of biometric and environmental measurements.

As previously noted, one or both of a set of wireless earpieces may include one or more projectors. In one embodiment, the set of wireless earpieces worn by a single user may be utilized to stereoscopically project content. Stereoscopic projection may also be performed utilizing multiple wireless earpieces worn by multiple users. During step 402, the wireless earpieces may also determine whether the wireless earpieces are being worn by different users. As a result, the logic and processes for projecting content maybe dynamically configured as needed. For example, different projection angles, intensities, focus points, zooming, skew, reflection, and other factors and conditions may be accounted for. The wireless earpieces may determine whether different users are utilizing a left wireless earpiece and a right wireless earpiece utilizing any number of processes, information, data, or measurements. In one embodiment, the wireless earpieces may utilize one or more of the distance between the wireless earpieces, skin/tissue conductivity, ear mapping, voice profile, user identifier (detected or provided by the respective users), or so forth. The wireless earpieces may utilize any number of thresholds or data to determine whether distinct users are utilizing the wireless earpieces. For example, if the distance between wireless earpieces is greater than one foot the wireless earpieces may determine the wireless earpieces are being worn by separate users. The distance between wireless earpieces may be determined utilizing one or more transceivers or other applicable information.

Next, the wireless earpieces determine whether a projection surface is available (step 404). A projection surface may represent any number of surfaces proximate the user wearing the wireless earpieces. In one embodiment, the wireless earpieces may analyze surfaces directly in front of the user. For example, the projectors of the wireless earpieces may be forward facing for projecting content in a direction easily visible to the user. In other examples, the projectors may point in any number of directions and maybe directed or focused as needed. The projection surface may represent any number of available surfaces whether smooth or rough. For example, some common projection services may include a desk, a screen, a display, a wall, a ceiling, a floor, a user's hand, or other surfaces of buildings, vehicles, structures, or environments near the user.

If the wireless earpieces determined the projection surface is unavailable during step 404, the wireless earpieces continue not projection operations of the wireless earpieces (step 406). The non-projection operations may include communications, audio playback, audio recording, biometric reading and reporting, and so forth.

If the wireless earpieces determined the projection surface is available during step 404, the wireless earpieces determine a distance to the projection surface (step 408). The distance may be determined utilizing any number of ranging or measurement processes. For example, a time required to reflect back and original signal may be processed to determine the distance to the projection surface. During step 408, the wireless earpieces may also perform surface mapping of the projection surface to determine the applicable shape, contours (e.g., bumps, ridges, flat spaces, etc.), and other information that may be utilized to format, focus, and project the content from the projectors of the wireless earpieces.

Next, the wireless earpieces direct and focus the projectors and prepare the content (step 410). The projectors may be positioned and oriented to project the content onto the projection surface. The projectors may also focus the content utilizing any number of optical components of the projectors, such as lenses, reflectors, refractors, and so forth. Any number of optical or formatting processes, algorithms, custom software, or so forth may be utilized as implemented by the components of the wireless earpieces.

The process of step 410 may be repeated during projection as described below in step 412 in response to movement of the user and warned wireless earpieces. For example, the wireless earpieces may attempt to compensate for motion of the user associated with the wireless earpieces. Image stability and continuity may be enhanced utilizing any number of standard projection or display processes, methodologies, and techniques.

Next, the wireless earpieces project the content on the projection surface (step 412). The content may be projected continuously, until acknowledged by a user, for a set time, or so forth.

The process of FIG. 4 maybe automatically implemented in response to determining there is available content. The user may specify at any time how, when, and where the content is projected. For example, the user may specify that text messages received from 6 AM to 7 AM are automatically projected onto the nearest available surface when the user is exercising. In another example, the user may specify that calendar entries are automatically played to the nearest available surface when the user is away from her residence. The user preferences may specify any number of conditions, factors, or information that are utilized to automatically or manually display content utilizing the projectors of the wireless earpieces. For example, some factors may include time of day, location of the user, battery status of the wireless earpieces, activity of the user, open applications, user input received, and so forth.

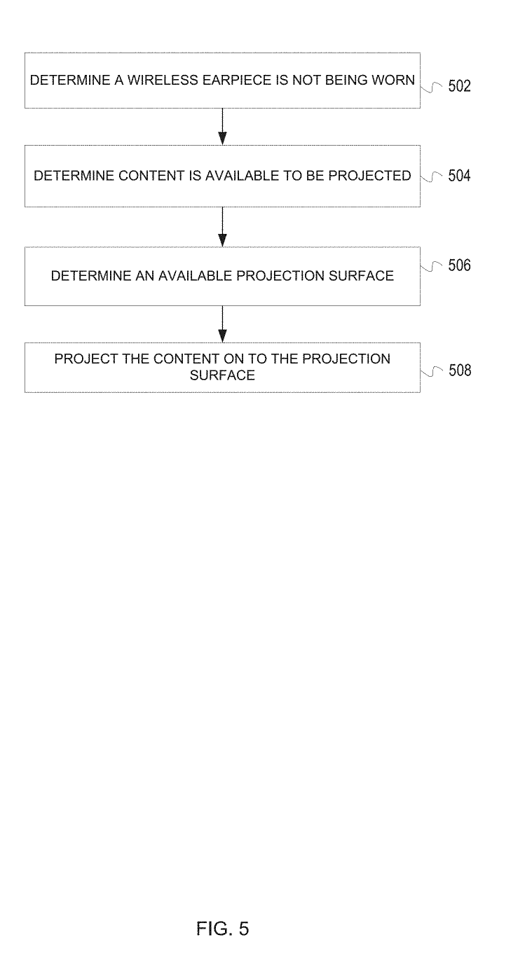

FIG. 5 is a flowchart of another process for projecting content from projector enhanced wireless earpieces in accordance with an illustrative embodiment. The process of FIG. 5 may be combined with the process of FIG. 4 or may represent additional processes and functionality that may be implemented. The process of FIG. 5 may begin by determining a wireless earpieces is not being worn (step 502). As described in FIG. 5, the wireless earpieces may utilize any number of components, sensors, or processes to determine whether they are being worn by a user. Any or all of the steps, processes, or description of FIG. 4 are also applicable to FIG. 5. During the process of FIG. 5, the wireless earpieces may be stored, charging, resting on a table, desk, or other surface, in a user's hand, or otherwise unworn by the user.

Next, the wireless earpieces determine whether content is available to be projected (step 504). The content may represent numerous types of information, images, video, or data. As noted, the user preferences may specify the types of content to be displayed by the wireless earpieces when not worn as well as how and when this type of projection is implemented.

Next, the wireless earpieces determine an available projection surface (step 506). As previously described, the nearest surfaces as well as available surfaces may be analyzed to determine one or more projection surfaces available to the wireless earpieces. In one embodiment, in response to determining that there are no acceptable projection surfaces, the wireless earpieces may prompt the user to hold up his hand, a notebook, or other object, approach a wall or other surface, or otherwise facilitate the projection process.

Next, the wireless earpieces project the content on to the projection surface (step 508). The projection surface may represent the nearest available surface to the wireless earpieces. During projection, the projectors may automatically orient the projected content or may perform orientation based on user input (e.g., “rotate 90 degrees”, “rotate 180 degrees”, etc.).

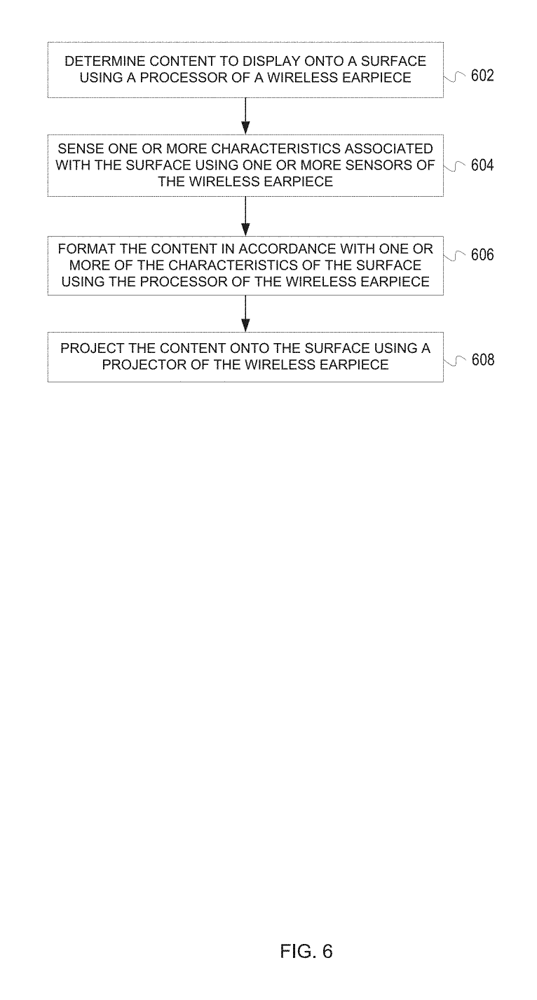

FIG. 6 illustrates a flowchart of a method of projecting content onto a surface using a wireless earpiece. The foregoing method may be incorporated into the methods described in FIG. 4 or FIG. 5 or even both methods. In step 602, a processor of the wireless earpiece is used to determine the content to display or project onto the surface. The content may be stored on a memory (such as the one described in FIG. 3 (312)), received from an external or third-party electronic device such as a smartphone, tablet, desktop computer (such as the one described in FIG. 1 (118)), laptop, a satellite, or radio communications tower, or streamed from the foregoing sources. The processor may also display or project the content in accordance with one or more user preferences. For example, the user may desire the content to be displayed with additional illuminance or brightness if the distance between the projector of the wireless earpiece and the surface is two or more meters. As another example, the user may desire the content to be projected with more contrast if the distance between the projector and the surface is small.

In step 604, one or more sensors of the wireless earpiece are used to sense one or more characteristics associated with the surface. The sensors may include optical sensors, infrared sensors, or other types of sensors capable of sensors capable of sensing electromagnetic radiation. Microphones may also be used. For example, an optical sensor may sense light indicative of the contour of the surface or a microphone may sense sounds indicative of the size or shape of the surface.

In step 606, the processor formats the content in accordance with the characteristics of the surface sensed by the sensors. For example, the processor may execute one or more programs or algorithms using the sounds sensed by the microphone and the light received by the optical sensor to determine the size of the surface, the shape of the surface and the contour of the surface and modify the content to maximize the readability of the content. If the contour of the surface is determined to be relatively inconducive for projecting content, the processor may incorporate a white background and add additional contrast to help a user see the content projected on the surface.

In step 608, the projector projects the content onto the surface. The content may be projected in a forward-facing direction relative to a user wearing the wireless earpiece using a forward-facing projector or the content may be projected to be seen by a third party proximate to the user using a side facing projector. The projector or projectors may be disposed within the wireless earpiece and protecting by a transparent lens or the projectors may protrude from the wireless earpiece and be attached to an actuator or other motive element. If the wireless earpiece is part of a set of wireless earpieces, the content may be projected stereoscopically by each of the wireless earpieces for a better viewing experience.

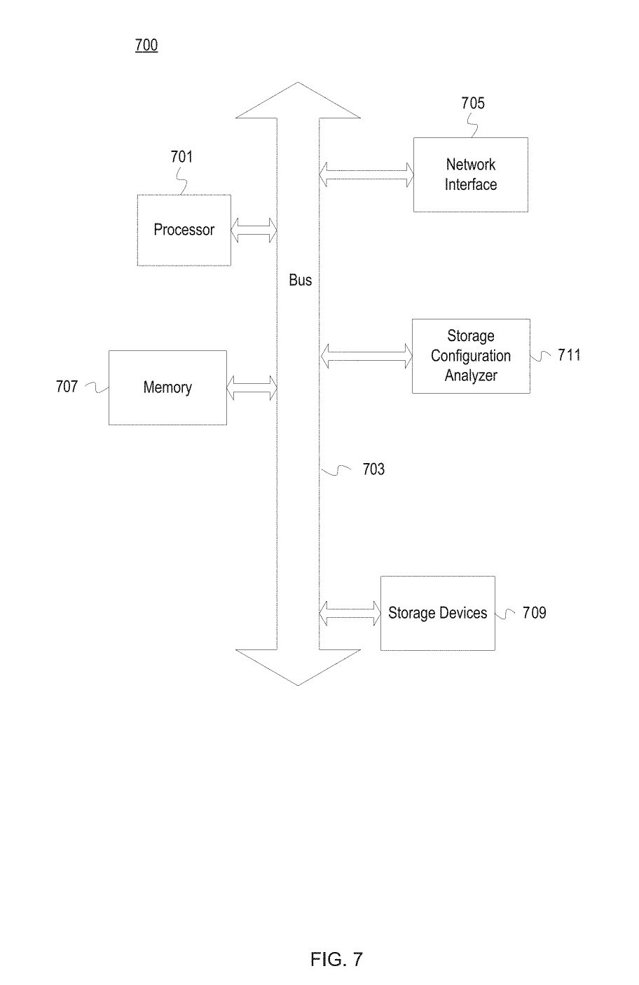

FIG. 7 depicts a computing system 700 in accordance with an illustrative embodiment. For example, the computing system 700 may represent a device, such as the wireless device 104 of FIG. 1. The computing system 700 includes a processor unit 701 (possibly including multiple processors, multiple cores, multiple nodes, and/or implementing multi-threading, etc.) and a memory 707. The memory 707 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computing system also includes a bus 703 (e.g., PCI, ISA, PCI-Express, HyperTransport®, InfiniBand®, NuBus, etc.), a network interface 705 (e.g., an ATM interface, an Ethernet interface, a Frame Relay interface, SONET interface, wireless interface, etc.), and a storage device(s) 709(e.g., optical storage, magnetic storage, etc.).

The system memory 707 embodies functionality to implement all or portions of the embodiments described above. The system memory 707 may include one or more applications or sets of instructions for controlling content streamed to the wireless earpieces to be output by the corresponding projectors. The system memory 707 may also store an application or interface for setting user preferences and controlling the content displayed by the projectors as well as how, when, and what content is displayed. In one embodiment, specialized sharing software may be stored in the system memory 707 and executed by the processor unit 701. As noted, the sharing application or software may be similar or distinct from the application or software utilized by the wireless earpieces. Code may be implemented in any of the other devices of the computing system 700. Any one of these functionalities may be partially (or entirely) implemented in hardware and/or on the processing unit 701. For example, the functionality may be implemented with an application specific integrated circuit, in logic implemented in the processing unit 701, in a co-processor on a peripheral device or card, etc. Further realizations may include fewer or additional components not illustrated in FIG. 7 (e.g., video cards, audio cards, additional network interfaces, peripheral devices, etc.). The processor unit 701, the storage device(s) 709, and the network interface 705 are coupled to the bus 703. Although illustrated as being coupled to the bus 703, the memory 707 may be coupled to the processor unit 701. The computing system 700 may further include any number of optical sensors, accelerometers, magnetometers, microphones, gyroscopes, temperature sensors, and so forth for verifying user biometrics, or environmental conditions, such as motion, light, or other events that may be associated with the wireless earpieces or their environment.

The features, steps, and components of the illustrative embodiments may be combined in any number of ways and are not limited specifically to those described. In particular, the illustrative embodiments contemplate numerous variations in the smart devices and communications described. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes or methods of the invention. It is understood that any other modifications, substitutions, and/or additions may be made, which are within the intended spirit and scope of the disclosure. For the foregoing, it can be seen that the disclosure accomplishes at least all of the intended objectives.

The previous detailed description is of a small number of embodiments for implementing the invention and is not intended to be limiting in scope. The following claims set forth a number of the embodiments of the invention disclosed with greater particularity.

The invention is not to be limited to the particular embodiments described herein. In particular, the invention contemplates numerous variations in the method of projecting content onto a surface using a projector of a wireless earpiece. The foregoing description has been presented for purposes of illustration and description. It is not intended to be an exhaustive list or limit any of the invention to the precise forms disclosed. It is contemplated that other alternatives or exemplary aspects are considered included in the invention. The description is merely examples of embodiments, processes or methods of the invention. It is understood that any other modifications, substitutions, and/or additions can be made, which are within the intended spirit and scope of the invention.

What is claimed is:

1. A method of projecting content onto a surface using a wireless earpiece, the method comprising:
using a processor of the wireless earpiece to determine the content to display onto the surface;
using at least one sensor of the wireless earpiece to sense at least one characteristic associated with the surface;
formatting, by the processor of the wireless earpiece, the content in accordance with the at least one characteristic associated with the surface; and
projecting the content onto the surface using a projector of the wireless earpiece.

2. The method of claim 1, wherein the content is determined in accordance with a selection provided by a user of the wireless earpiece.

3. The method of claim 1, wherein the determining of the content is automatically performed in accordance with user preferences.

4. The method of claim 1, wherein the at least one characteristic is selected from a set comprising a distance between the wireless earpiece and the surface, a shape associated with the surface, and a contour associated with the surface.

5. The method of claim 1, wherein the wireless earpiece comprises a set of wireless earpieces and the projector of each earpiece is forward facing.

6. The method of claim 5, further comprising determining a mode of operation associated with the set of wireless earpieces, wherein the mode of operation is a set comprising a normal mode of operation, a shared mode of operation, and a flashlight mode.

7. The method of claim 6, wherein in the shared mode of operation the content is projected stereoscopically onto the surface by the set of wireless earpieces.

8. The method of claim 6, wherein in the shared mode of operation at least one wireless earpiece of the set of wireless earpieces determines a second surface to display the content, determines at least one characteristic associated with the second surface, formats the content in accordance with the at least one characteristic associated with the second surface, and projects the content onto the second surface using a second projector associated with the at least one wireless earpiece.

9. The method of claim 6, wherein in the shared mode of operation at least one wireless earpiece of the set of wireless earpieces determines a second surface to display the content, determines additional content to display on the second surface, determines at least one characteristic associated with the second surface, formats the additional content in accordance with the at least one characteristic associated with the second surface, and projects the additional content onto the second surface using a second projector associated with the at least one wireless earpiece.

10. The method of claim 1, further comprising orienting the projector in response to a movement by a user.

11. A wireless earpiece comprising:
an earpiece housing;
a processor disposed within the earpiece housing;
at least one sensor operatively connected to the processor; and
a projector operatively connected to the processor;
wherein the processor is configured to determine content to be displayed in accordance with a user preference and at least one characteristic associated with a surface using data measured by the at least one sensor; and
wherein the projector is configured to project the content onto the surface in accordance with the at least one characteristic associated with the surface.

12. The wireless earpiece of claim 11, wherein the at least one sensor includes a radar sensor and the data comprises the position of at least one object sensed by the radar sensor and at least one characteristic associated with the at least one object.

13. The wireless earpiece of claim 12, wherein the processor is further configured to use the data to select the surface from the at least one object sensed by the radar sensor to project the content.

14. The wireless earpiece of claim 11, wherein the at least one characteristic is selected from a set comprising a distance between the wireless earpiece and the surface, a shape associated with the surface, and a contour associated with the surface.

15. The wireless earpiece of claim 11, wherein the projector is positioned on the earpiece housing to project the content in a forward direction when the wireless earpiece is worn by a user.

16. The wireless earpiece of claim 11, wherein the projector is disposed within the earpiece housing and enclosed by a substantially transparent material.

17. The wireless earpiece of claim 11, wherein the projector comprises an actuator configured to orient the projector toward the surface and wherein the projector protrudes from the earpiece housing.

18. The wireless earpiece of claim 17, wherein the projector is oriented in accordance with a factor selected from a set comprising a projection angle, an intensity, a focus point, a zoom factor, a skew factor, and reflection from the surface.

19. The wireless earpiece of claim 11, further comprising a second projector positioned on the earpiece housing to project the content in a backward direction when the wireless earpiece is worn by a user.

20. The wireless earpiece of claim 11, wherein the projector comprises a laser positioned to emit the content at a microelectromechanical mirror for projecting the content onto the surface.
